(19) United States
(12) Patent Application Publication
(10) Pub. No.: US 2013/0000729 A1
(43) Pub. Date: Jan. 3, 2013

(54) DEF PUMP AND TANK THAWING SYSTEM AND METHOD

(75) Inventors: Mahesh K. Mokire, Dunlap, IL (US); Jinhui Sun, Dunlap, IL (US); Jack A. Merchant, Peoria, IL (US); Raymond U. Isada, Peoria, IL (US); Yong Yi, Dunlap, IL (US); Daniel R. Wentzel, Dunlap, IL (US)

(73) Assignee: Caterpillar Inc., Peoria, IL (US)

(21) Appl. No.: 13/173,509

(22) Filed: Jun. 30, 2011

(51) Int. Cl. F24H 9/12; F16L 53/00

(52) U.S. Cl. 137/1; 137/340

(57) ABSTRACT

A fluid supply system configured to be utilized with a coolant system of an engine, the fluid supply system including; a fluid tank, a fluid pump coupled to the fluid tank and a thermal management system in thermal communication with the fluid tank and the fluid pump, wherein the thermal management system includes; a first coolant circuit in thermal communication with the fluid tank and a second coolant circuit in thermal communication with the fluid pump, wherein flow of coolant from the coolant system through the first fluid circuit and second fluid circuit is in parallel when coolant flows through the second fluid circuit.

### TECHNICAL FIELD

The present disclosure relates to engine exhaust aftertreatment systems and more particularly to a pump and tank unit used in providing a reductant to exhaust aftertreatment systems.

### BACKGROUND

A selective catalytic reduction (SCR) system may be included in an exhaust treatment or aftertreatment system for a power system to remove or reduce nitrous oxide (NOx or NO) emissions coming from the exhaust of an engine. SCR systems use reductants, such as urea, that are introduced into the exhaust stream.

United States Patent Publication US 20100095653A1 (the '653 publication) discloses an aftertreatment system including an SCR system. The SCR system includes a reductant solution tank. A heating component is associated with the reductant solution tank and receives an input based on signals from a temperature sensor and a pressure sensor.

### SUMMARY

The present disclosure provides a fluid supply system configured to be fluidly coupled to a coolant system of an engine. The fluid supply system may include; a fluid tank, a fluid pump fluidly coupled to the fluid tank and a thermal management system in thermal communication with the fluid tank and the fluid pump. The thermal management system may includes a first coolant circuit in thermal communication with the fluid tank and a second coolant circuit in thermal communication with the fluid pump. The first fluid circuit and second fluid circuit are configured to be fluidly coupled to the coolant system. The first coolant circuit is arranged in parallel to the second fluid circuit.

The present disclosure also provides a method of thermally managing a fluid supply system that includes a fluid tank, a fluid pump coupled to the fluid tank and a thermal management system in thermal communication with the fluid tank and the fluid pump. Such a method includes selectively supplying coolant from an engine to a first coolant circuit in thermal communication with the fluid tank, selectively supplying the coolant to a second coolant circuit in thermal communication with the fluid pump, and returning the coolant from at least one of the first coolant circuit and the second coolant circuit to the engine, wherein the flow of the coolant through the first fluid circuit and second fluid circuit is in parallel when coolant flows through the second fluid circuit.

### BRIEF DESCRIPTION OF THE DRAWINGS

FIG. 1 is a diagrammatic view of a machine including a power system with an engine and an aftertreatment system.

FIG. 2 is a diagrammatic view of a reductant tank and pump and associated coolant lines according to one embodiment of the present disclosure.

FIG. 3 is a graph illustrating, for one exemplary embodiment, analytical results regarding a time required to thaw a reductant pump and a time required to over-heat the reductant pump according to a coolant flow rate through the reductant pump at a predefined coolant input temperature.

### DETAILED DESCRIPTION

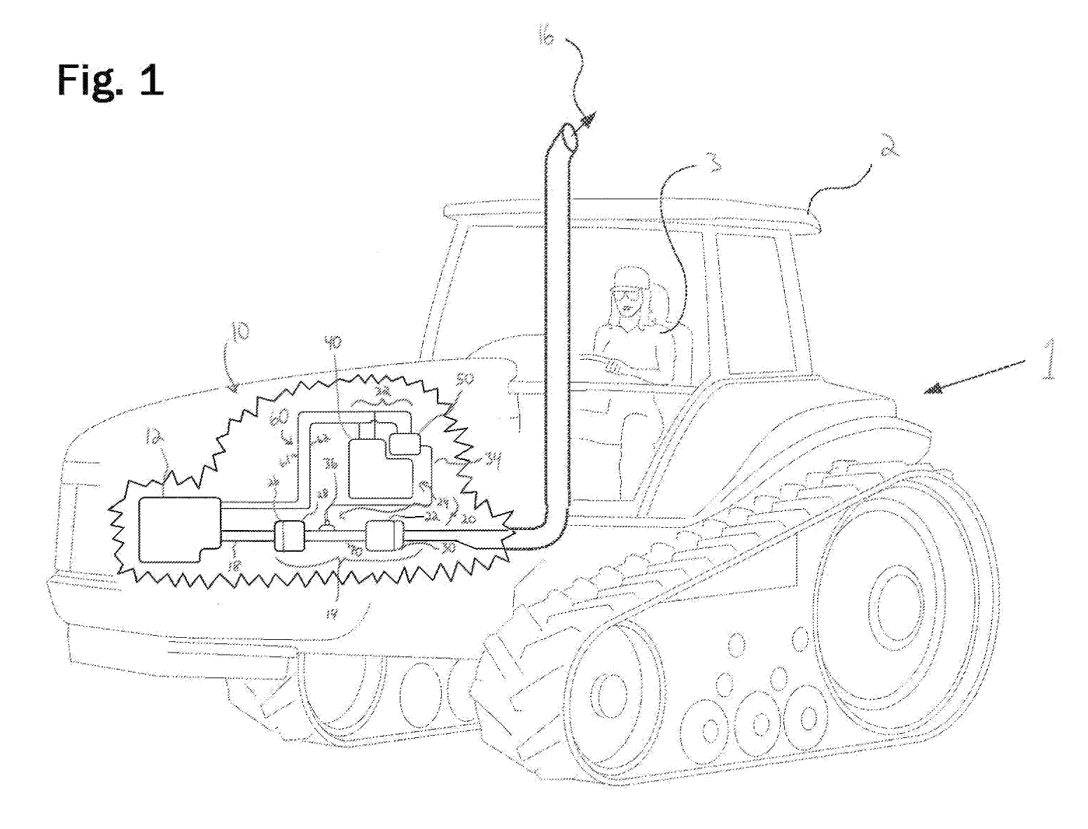

FIG. 1 shows a machine 1 including a cab 2 where an operator 3 sits and a power system 10. The machine 1 might be a tractor (as illustrated), on-highway truck, car, vehicle, off-highway truck, earth moving equipment, material handler, logging machine, compactor, construction equipment, stationary power generator, pump, aerospace application, locomotive application, marine application, or any other device or application requiring a power system 10.

The power system 10 includes an engine 12 and an aftertreatment system 14 to treat an exhaust stream 16 produced by the engine 12. The engine 12 may include other features not shown, such as controllers, fuel systems, air systems, cooling systems, peripheries, drive-train components, turbochargers, exhaust gas recirculation systems, etc. The engine 12 may be any type of engine (internal combustion, gas, diesel, gaseous fuel, natural gas, propane, etc.), may be of any size, with any number of cylinders, any type of combustion chamber (cylindrical, rotary spark ignition, compression ignition, 4-stroke and 2-stroke, etc.), and in any configuration (“V,” in-line, radial, etc.).

The aftertreatment system 14 includes an exhaust conduit 18 delivering the exhaust stream 16 and a Selective Catalytic Reduction (SCR) system 20. The SCR system 20 includes an SCR catalyst 22, and a reductant supply assembly 24.

In some embodiments, the aftertreatment system 14 may also include a diesel oxidation catalyst (DOC) 26, a diesel particulate filter (DPF) 28, and a clean-up catalyst 30. The DOC 26, DPF 28, SCR catalyst 22, and clean-up catalyst 30 include the appropriate catalyst or other material, respective of their intended functions, disposed on a substrate. The substrate may consist of cordierite, silicon carbide, other ceramic, or a metal structure. The substrates may form a honeycomb structure with a plurality of channels or cells for the exhaust stream 16 to pass through. The DOC 26, DPF 28, SCR catalyst 22, and clean-up catalyst 30 substrates may be housed in canisters, as shown, or may be integrated into the exhaust conduit 18 (not shown). The DOC 26 and DPF 28 may be in the same canister, as shown, or may be separately disposed. Likewise, the SCR catalyst 22 and clean-up catalyst 30 may also be in the same canister, as shown, or may be separately disposed.

The aftertreatment system 14 is configured to remove, collect, or convert undesired constituents from the exhaust stream 16. The DOC 26 oxidizes carbon monoxide (CO) and unburnt hydrocarbons (HC) into carbon dioxide (CO2) and water (H2O). The DPF 28 collects particulate matter or soot. The SCR catalyst 22 is configured to reduce an amount of nitrous oxides (NOx) in the exhaust stream 16 in the presence of a reductant, e.g., diesel exhaust fluid (DEF).

The clean-up catalyst 30 may embody an ammonia oxidation catalyst (AMOX). The clean-up catalyst 30 is configured to capture, store, oxidize, reduce, and/or convert reductant that may slip past or breakthrough the SCR catalyst 22. The clean-up catalyst 30 may also be configured to capture, store, oxidize, reduce, and/or convert other constituents present in the exhaust stream.

In the illustrated embodiment, the exhaust stream 16 exits the engine 12, passes through the DOC 26, DPF 28, passes through the SCR system 20, and then passes through the clean-up catalyst 30 via the exhaust conduit 18. In the illustrated embodiment, the SCR system 20 is downstream of the DPF 28 and the DOC 26 is upstream of the DPF 28. The clean-up catalyst 30 is downstream of the SCR system 20. In other embodiments, these devices may be arranged in a variety of orders and may be combined together in different combinations. In one embodiment, the SCR catalyst 22 may be combined with the DPF 28, with the catalyst material for the SCR being deposited on the DPF 28. Other exhaust treatment devices may also be located upstream, downstream, or within the SCR system 20.

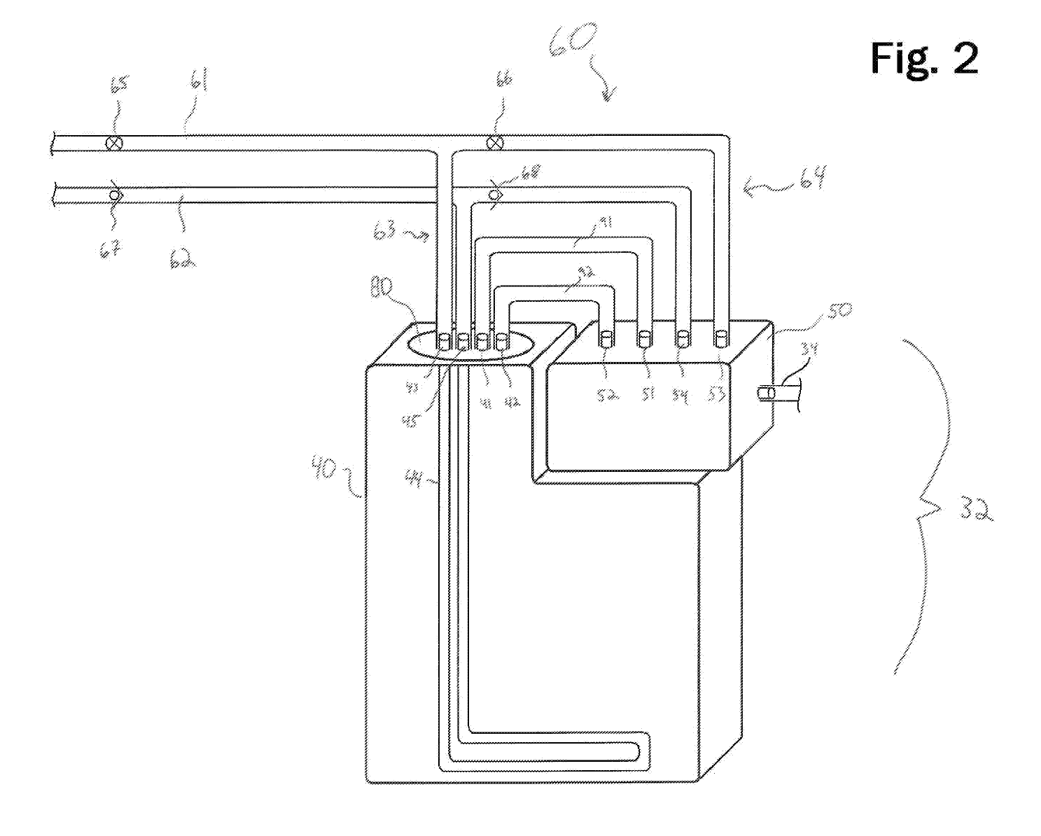

The reductant supply assembly 24 is configured to introduce the reductant in to the exhaust upstream of the SCR catalyst 22. The reductant supply assembly 24 may include a reductant source 32, which may also be referred to hereinafter as a pump tank unit (PTU) 32, reductant lines 34, and an injector 36. In the embodiment illustrated in FIGS. 1 and 2, the PTU 32 generally includes a tank 40 and a pump 50. According to various alternative embodiments, the pump 50 may be mounted to the tank 40, such that the tank 40 supplies vertical and horizontal support to the pump 50.

The reductant supply system 24 may also include a thermal management system 60 to thaw frozen reductant, prevent reductant from freezing, and /or prevent reductant from overheating in the reductant lines 34, the tank 40 and the pump 50. One or more components of the reductant supply system 24 may also be insulated to prevent overheating and/or freezing of the reductant. According to one exemplary embodiment, the thermal management system 60 includes an engine coolant supply line 61 and an engine coolant return line 62. The thermal management system 60 will be discussed in more detail below with respect to FIG. 2.

The reductant supply system 24 may also include an air assist system (not shown) for introducing compressed air into the exhaust conduit 18. The air assist system may also be used to purge the reductant line 34 and other reductant supply system 24 components of reductant when not in use. Alternative exemplary embodiments include configurations wherein the air assist system is omitted.

The injector 36 injects reductant in a mixing section 70 of the exhaust conduit 18 where the reductant may be converted and mix with the exhaust stream 16. A mixer (not shown) may also be included in the mixing section 70 to assist the conversion and mixing. While other reductants are possible, urea is the most common reductant. The urea reductant converts, decomposes, or hydrolyzes into ammonia (NH3) and is then adsorbed or otherwise stored in the SCR catalyst 22. The NH3 is then consumed in the SCR catalyst 22 through a reduction of NOx into nitrogen gas (N2).

A heat source (not shown) may also be included to remove soot from the DPF 28 in a process referred to as regeneration. The heat source may also thermally manage the SCR catalyst 22, DOC 26, or clean-up catalyst 30, to remove sulfur from the DOC 26, DPF 28, or SCR catalyst 22, or to remove deposits of reductant that may have formed in any of those components or along the exhaust conduit 18. The heat source may embody a burner, hydrocarbon dosing system that creates an exothermic reaction on the DOC 46, electric heating element, microwave device, or other heat source. The heat source may also be provided by operating the engine 12 under conditions to generate elevated exhaust stream 16 temperatures. The heat source may also be provided by a backpressure valve or another restriction in the exhaust conduit 18 that causes elevated exhaust stream 16 temperatures.

The aftertreatment system 14 may also include a control system (not shown) with NOx sensors (not shown). The control system may use the NOx sensor or engine maps to control the introduction of reductant from the reductant supply system 24 to achieve the level of NOx reduction required while controlling ammonia slip. The control system may also include soot sensors (not shown) associated with the DPF 28 to control regeneration of the DPF 28.

Referring now to FIG. 2, the PTU 32 includes the tank 40 and the pump 50. The PTU 32 may also include a header 80 disposed on the tank 40 in order to facilitate connections between the tank 40 and other components of the PTU 32. In one exemplary embodiment, the header 80 includes a tank reductant supply connection 41 for connecting to a reductant supply line 91 and a tank reductant return connection 42 for connecting to a reductant return line 92. The pump 50 includes a pump reductant supply connection 51 which connects to the reductant supply line 91 to draw reductant from the tank 40. The pump 50 also includes a pump reductant return connection 52 which connects to the reductant return line 92 to return reductant to the tank 40, e.g., during a purging event. Alternative exemplary embodiments include configurations wherein the reductant return components, e.g., the tank reductant return connection 42, the reductant return line 92 and the pump reductant return connection 52 are omitted. According to various alternative embodiments, the tank 40 may include various additional ports and features, such as a filling spout and cap assembly, a drain and plug assembly, fasteners for physically mounting the pump 50 to the tank 40, etc.

As illustrated in FIG. 2, the thermal management system 60 includes an engine coolant supply line 61 and an engine coolant return line 62, both of which are fluidly connected to an engine coolant circulation system (not shown) within the engine 12. In one exemplary embodiment, the engine coolant supply line 61 is connected to the engine 12 immediately adjacent to a water pump (not shown) of the engine 12 and the coolant return line 62 returns the engine coolant to a location downstream of the location from which the engine coolant supply line 61 is connected. In the present exemplary embodiment, the engine coolant supply line 61 diverts only a small portion of the engine coolant being circulated in the engine 12 to be used in the thermal management system 60, e.g., in one exemplary embodiment the engine coolant supply line 61 diverts 5% or less of the total engine coolant flow from the water pump. However, the present disclosure is not limited thereto, and a greater or lesser proportion of the engine coolant flow may be diverted through the thermal management system 60. The engine coolant that is not diverted is circulated within the engine 12 in order to provide cooling to the engine 12.

The thermal management system 60 includes a first coolant circuit 63 in thermal communication with the tank 40 and a second coolant circuit 64 in thermal communication with the pump 50. The first coolant circuit 63 and the second coolant circuit 64 may be used to route coolant from the engine 12 into the tank 40 and pump 50 in order to thaw the reductant in the tank 40 and pump 50, or to prevent the reductant in the tank 40 and pump 50 from freezing, as will be discussed in more detail below.

The first coolant circuit 63 routes coolant from the engine coolant supply line 61 into a tank coolant inlet connection 43 and then into a coolant loop 44 before returning the coolant to the engine coolant return line 62 via a tank coolant outlet connection 45. The second coolant circuit 64 routes coolant from the engine coolant supply line 61 into a pump coolant inlet connection 53 and then into the pump 50 before returning the coolant to the engine coolant return line 62 via a pump coolant outlet connection 54. Alternative embodiments include configurations wherein the coolant loop 44 has various shapes and sizes other than that illustrated in FIG. 2.

The thermal management system 60 includes a first control valve 65 disposed upstream of the first coolant circuit 63 and the second coolant circuit 64. In one embodiment, the first control valve 65 may be disposed in the engine coolant supply line 61, although alternative embodiments may include alternative placements for the first control valve 65, e.g., in the engine 12 itself. The first control valve 65 may be used to substantially block coolant flow to the first coolant circuit 63 and the second coolant circuit 64. Embodiments include configurations wherein the first control valve 65 may block as much as 100% of coolant flow into the first coolant circuit 63 and the second coolant circuit 64.

In one exemplary embodiment, the thermal management system 60 also includes a second control valve 66 disposed upstream of the second coolant circuit 64. The second control valve 66 may be used to substantially block coolant flow to the second coolant circuit 64. Embodiments include configurations wherein the second control valve 66 may block as much as 100% of coolant flow into the second coolant circuit 64. The first control valve 65 and/or the second control valve 66 may be controlled by a controller (not shown).

The thermal management system 60 also includes a first check valve 67 disposed downstream of the first coolant circuit 63 and the second coolant circuit 64. In one embodiment, the first check valve 67 may be disposed in the engine coolant return line 62, although alternative embodiments may include alternative placements for the first check valve 67, e.g., in the engine 12 itself. The first check valve 67 may be used to substantially block a coolant flow in a direction towards the first coolant circuit 63 and the second coolant circuit 64, while still allowing coolant to flow in the opposite direction away from the first coolant circuit 63 and the second coolant circuit 64. Embodiments include configurations wherein the first check valve 67 may block as much as 100% of coolant flow in a direction towards the first coolant circuit 63 and the second coolant circuit 64.

In one embodiment, the thermal management system 60 also includes a second check valve 68 disposed at a downstream location within the second coolant circuit 64. In one embodiment, the second check valve 68 may be used to substantially block a coolant flow in a direction towards the second coolant circuit 64, while still allowing coolant to flow in the opposite direction away from the second coolant circuit 64. Embodiments include configurations wherein the second check valve 68 may block as much as 100% of coolant flow in a direction towards the second coolant circuit.

In an alternative exemplary embodiment (not shown), the second control valve 66 and/or the second check valve may be omitted and flow through the second coolant circuit 64 may be controlled via a predetermined ratio of a conduit in the first coolant circuit 63 and a conduit in the second coolant circuit 64. The control of coolant through the first coolant circuit 63 and the second coolant circuit 64 will be discussed in more detail below.

Alternative placements of the second control valve 66 and second check valve 68 relative to what is illustrated in FIG. 2 are also possible. For example, in one alternative embodiment, both the second control valve 66 and the second check valve 68 may be disposed on the header 80. In another embodiment, the header 80 may itself include internal passages and valves for accomplishing the flow paths and controls discussed in more detail below.

### INDUSTRIAL APPLICABILITY

Emissions regulations have only recently led to the use of SCR systems 20. Prior art SCR systems may or may not utilize thermal management systems in order to prevent freezing of reductant, e.g., DEF, in a reductant storage tank and/or a reductant pump. Some prior art systems may utilize an electrical heating type thermal management system. However, these types of thermal management systems put an undesirable strain on machine electricity generating systems or requires a larger, and more expensive, electricity generating system, e.g., a larger alternator. Alternative prior art systems may alternatively, or in addition, utilize engine coolant type thermal management systems.

When present, the engine coolant type thermal management systems of prior art SCR systems tend to only thaw the reductant tank, or if they do additionally thaw the reductant pump, the engine coolant flows through the tank and pump in series. Such systems are arranged with the engine coolant either flowing through the tank and then the pump or flowing through the pump and then the tank. The pump typically has much less thermal mass than the tank, and thus relatively hot engine coolant continues to flow through the pump long after the pump has been thawed, i.e., after a pump thawing time, in order to achieve thawing of the larger thermal mass tank. The time required to thaw the tank sufficient to provide reductant to the pump may be referred to as a tank thawing time. Continued heating of the pump after the pump thawing time may lead to wear, and ultimately failure, of the pump. The time required to heat the pump to a predefined temperature at which damage to the pump occurs may be referred to as a pump overheating time. The predefined temperature is often determined by the manufacturer of the pump based on engineering standards such as those set forth by the International Standards Organization (ISO) and the American National Standards Institute (ANSI), the American Society of Mechanical Engineers (ASME) and various other similar organizations. Thus, the prior art systems can cause damage to the pump.

According to various exemplary and alternative embodiments, the thermal management system 60 is configured such that the first coolant circuit 63 is arranged in parallel to the second coolant circuit 64 so that the flow of coolant to the tank 40 and pump 50 is also in parallel. Flow rates through the first coolant circuit 63 and the second coolant circuit 64 may be controlled with respect to one another, and overheating of the pump 50 may be avoided.

Referring to FIGS. 1 and 2, when it is determined that the reductant in the tank 40 and/or pump 50 is below a predetermined threshold temperature, the thermal management system 60 may allow for the flow of coolant to the first coolant circuit 63 and the second coolant circuit 64 by opening the first coolant control valve 65. In one embodiment, the predetermined temperature is a temperature at which the reductant freezes at standard atmospheric pressures. According to various alternative embodiments, the temperature determination may be made via a variety of sensors disposed in various locations around the PTU 32.

After a determination that the reductant temperature is below the predetermined temperature, e.g., upon initial start-up of the machine 1 after an overnight shut-down period in a cold climate, the thermal management system 60 receives the coolant and directs the coolant to both the first coolant circuit 63 and the second coolant circuit 64. The coolant is heated by internal combustion processes within the engine 12; that is, the coolant has absorbed thermal energy from the engine 12. The thermal energy in the coolant is transferred to the reductant in the tank 40 by the first coolant circuit 63 and to the reductant in the pump 50 by the second coolant circuit 64. The transferred thermal energy causes a phase transition in the reductant in the tank 40 and the pump 50. The parallel nature of flow between the first coolant circuit 63 and the second coolant circuit 64 allows for parallel thermal energy transfer to the tank 40 and pump 50.

The second control valve 66 controls the flow rate of coolant in the second coolant circuit 64. In one embodiment, after reductant in the pump 50 is thawed, i.e., after a pump thawing time, coolant flow to the second coolant circuit 64 may be reduced or entirely stopped by the second control valve 66. In another embodiment, the second control valve 66 may control the flow rate of coolant in the second coolant circuit 64 to be less than a flow rate through the first coolant circuit 63. Alternatively, the control valve 66 may be omitted, or used only as a redundancy, and a flow rate of coolant in the second coolant circuit 64 may be controlled relative to coolant flow in the first coolant circuit 63 in other ways, such as by controlling a ratio of a diameter of a conduit in the first coolant circuit 63 and a diameter of a conduit in the second coolant circuit 64, or by including a flow restriction within one or both of the first coolant circuit 63 and the second coolant circuit 64. These ratios or flow restrictions may be predetermined to provide a greater coolant flow rate in the first coolant circuit 63 than in the second coolant circuit 64. In either embodiment, a maximum flow rate at the second coolant circuit 64 may be predetermined based at least in part on a predicted or measured maximum coolant temperature such that a fluid pump overheating time as a function of the maximum flow rate and the maximum coolant temperature is greater than a fluid tank thawing time.

Meanwhile, coolant flow to the tank 40 may continue until reductant in the tank 40 is thawed, i.e., for the duration of a tank thawing time. The large thermal mass of the reductant in the tank 40 and the relatively smaller thermal mass of reductant in the pump 50 means that the tank thawing time is usually longer than the pump thawing time. In some applications, depending on pump characteristics, the tank thawing time is actually greater than the pump overheating time described above. However, because the present disclosure allows for parallel flow between the first coolant circuit 63 and the second coolant circuit 64, even if the tank thawing time is greater than the pump overheating time, coolant flow to the tank 40 may be isolated from coolant flow to the pump 50 or flow to the tank 40 may be significantly greater than flow to the pump 50, and thereby damage to the pump 50 may be avoided while the tank 40 is adequately thawed.

While the above embodiment is described with respect to beginning coolant flow to the tank 40 and pump 50 simultaneously and then reducing or entirely stopping coolant flow to the pump 50 after a pump thawing time, alternative embodiments include configurations wherein the coolant is only directed to the second coolant circuit 64 after the reductant in the tank 40 has at least partially thawed. Various modifications on the thawing control strategy are also possible, such as pulse-width modulation of the coolant flow through either type tank 40 and/or pump 50.

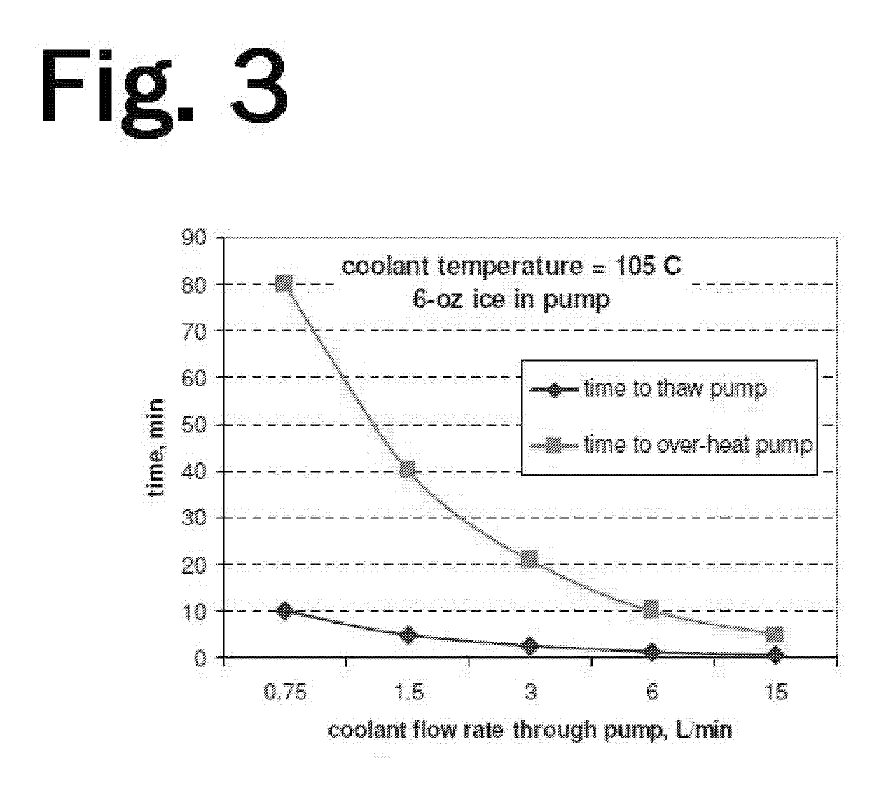

FIG. 3 is a graph illustrating, for one exemplary embodiment, analytical results regarding a time required to thaw a reductant pump and a time required to over-heat the reductant pump according to a coolant flow rate through the reductant pump at a predefined coolant input temperature.

In order to meet certain regulatory requirements, a reductant tank thawing time must be less than a predefined time period, e.g., the tank thawing time must be equal to or less than 40 minutes. As used herein with respect to the experimental example, the tank thawing time refers to a time required to thaw 10% of a particular exemplary embodiment of a 15-gallon version of tank 40.

The tank thawing time, a pump thawing time, and a pump overheating time for a particular exemplary embodiment of a tank 40 and pump 50 may be analytically calculated at various coolant flow rates. As used herein, the pump thawing time refers to a time required to thaw six ounces of reductant ice in the particular exemplary embodiment of a pump 50 to a liquid state. As used herein, the pump overheating time refers to a time required to heat the particular exemplary embodiment of a pump 50 to about 100° C. As discussed above, the tank thawing time, the pump thawing time and pump overheating time are particular to the model of tank 40 and pump 50 that may be used and may vary accordingly.

It was analytically calculated that the tank thawing time for the particular exemplary embodiment of a 15 gallon tank 40 is about 27 minutes when 50° C. coolant is flowed therethrough at about 6 L/minute. The tank thawing time is reduced to about 17 minutes if the temperature of the coolant flowing therethrough is increased to about 80° C. and the tank thawing time is increasingly reduced to about 14 minutes if the temperature of the coolant flowing therethrough is increased to about 105° C.

However, it was also analytically calculated that, at the typical engine operating conditions discussed above, the pump overheating time for the particular exemplary embodiment described above is shorter than the tank thawing time, e.g., when the coolant flow rate is 6 L/minute and the coolant temperature is 105° C., the pump overheating time is about 10 minutes, and thus damage to the particular exemplary embodiment of a pump 50 may occur before the tank thawing time elapses. Similarly, if the coolant flow rate and/or temperature is increased, the tank thawing time may be decreased, but the pump overheating time is correspondingly decreased. If the coolant flow rate and/or temperature is decreased, the pump overheating time may be increased, but the tank thawing time may be increased such that it is greater than the regulatory requirement, e.g., greater than 40 minutes.

The present disclosure provides a means for avoiding pump 50 overheating while still being able to effectively thaw the tank 40 in the regulatorily proscribed time period by providing the pump 50 and tank 40 with partially independent coolant circuits as discussed above. Thus, the flow rate through the tank 40 does not have to equal the flow rate through the pump 50. Various control strategies may be implemented in order to control flow through the coolant circuits 63 and 64, such as shutting off flow to the pump 50 after a predetermined time, or reducing a flow rate through the second cooling circuit 64 for an entire operating period of the thermal management system 60. In one embodiment coolant flow through the first coolant circuit 63 may be continued while the reductant in the tank 40 is frozen and coolant flow though the second coolant circuit 64 is reduced or stopped after frozen reductant in the pump 50 is thawed.

An experimental determination of a pump thawing time and a pump overheating time are illustrated as a function of a coolant flow rate through the pump 50 in FIG. 3. In the experimental example, the coolant temperature introduced to the pump 50 was 105° C. and the pump 50 started with six ounces of reductant ice therein. The pump overheating time (line with square icons) and the pump thawing time (line with diamond icons) show a strong dependence between pump heating and coolant flow rate. As the coolant flow rate increases, both the pump thawing time and the pump overheating time decrease. The graph of FIG. 3 indicates that a coolant flow rate of about 1.5 L/min may result in a pump thawing time of about 5 minutes and a pump overheating time of slightly more than 40 minutes. Thus, if the coolant flow rate through the pump 50 is about 1.5 L/min as controlled by the second valve 66 or a ratio of conduit sizes or other various flow restrictions, the thermal management system 60 may flow coolant through both the tank 40 and the pump 50 through the first coolant circuit 63 and the second coolant circuit 64, respectively, for the entire regulatorily proscribed period of about 40 minutes without overheating the pump 50. If the coolant flow rate through the second coolant circuit 64 is less than about 1.5 L/min, the pump overheating time can be increased while the pump thawing time is still within the regulatorily proscribed period, e.g., the pump overheating time may be increased to about 80 minutes if the coolant flow rate is about 0.75 L/min while the pump thawing time is about 10 minutes.

In one embodiment, a maximum flow rate at the second coolant circuit 64 is predetermined based at least in part on a predicted or measured maximum coolant temperature as delivered by the engine 12 such that a pump overheating time as a function of the maximum flow rate at the second coolant circuit 64 and the maximum coolant temperature is greater than a fluid tank thawing time.

Thus, the tank 40 may be thawed by the first coolant circuit 63 having a first flow rate and the pump 50 may be thawed by the second coolant circuit 64 which may have a different flow rate than the first coolant circuit 63, or may have flow turned off while coolant flows through only the first coolant circuit 63. In such a case, overheating of the pump 50 may be avoided while sufficient thermal energy is transferred to the tank 40 to ensure thawing within the regulatorily proscribed period.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A fluid supply system configured to be fluidly coupled to a coolant system of an engine, the fluid supply system comprising:
a fluid tank;
a fluid pump fluidly coupled to the fluid tank; and
a thermal management system in thermal communication with the fluid tank and the fluid pump,
wherein the thermal management system includes:
a first coolant circuit in thermal communication with the fluid tank; and
a second coolant circuit in thermal communication with the fluid pump,
wherein the first fluid circuit and second fluid circuit are configured to be fluidly coupled to the coolant system; and
wherein the first coolant circuit is arranged in parallel to the second fluid circuit.

2. The fluid supply system of claim 1, wherein a flow rate of coolant in the second coolant circuit is controllable relative to a flow rate of coolant in the first coolant circuit.

3. The fluid supply system of claim 2, further including:
a second coolant circuit valve that is disposed in the second coolant circuit that is configured to control a flow rate of coolant in the second coolant circuit relative to a flow rate of coolant in the first coolant circuit; and
a controller configured to control the second coolant circuit control valve.

4. The fluid supply system of claim 3, wherein the controller is configured to control the flow rate of coolant in the second coolant circuit determined based on a temperature of the coolant.

5. The fluid supply system of claim 3, wherein the controller is configured to control the flow rate within the second coolant circuit such that a fluid pump overheating time is greater than a fluid tank thawing time.

6. The fluid supply system of claim 3, wherein the controller is configured to control the flow rate within the second coolant circuit to be equal to or less than 1.5 liters per minute when a temperature of the coolant is equal to or less than about 105° C.

7. The fluid supply system of claim 6, wherein the controller is configured to control the flow rate within the second coolant circuit to be equal to or less than 0.75 liters per minute when a temperature of the coolant is equal to or less than about 105° C.

8. The fluid supply system of claim 2, wherein a ratio of a first diameter of a conduit in the first coolant circuit and a second diameter of a conduit in the second coolant circuit is predetermined to provide a greater coolant flow rate in the first coolant circuit than in the second coolant circuit.

9. The fluid supply system of claim 8, wherein the ratio is predetermined to control a maximum flow rate at the second coolant circuit is based at least in part on a maximum coolant temperature such that a fluid pump overheating time as a function of the maximum flow rate and the maximum coolant temperature is greater than a fluid tank thawing time.

10. The fluid supply system of claim 1, further including a first valve disposed upstream of both the first coolant circuit and the second coolant circuit.

11. The fluid supply system of claim 1, wherein the fluid pump is mounted on the fluid tank.

12. The fluid supply system of claim 1, wherein the fluid is a reductant.

13. A method of thermally managing a fluid supply system, the fluid supply system comprising a fluid tank, a fluid pump coupled to the fluid tank and a thermal management system in thermal communication with the fluid tank and the fluid pump, the method comprising:
selectively supplying coolant from an engine to a first coolant circuit in thermal communication with the fluid tank;
selectively supplying the coolant to a second coolant circuit in thermal communication with the fluid pump; and
returning the coolant from at least one of the first coolant circuit and the second coolant circuit to the engine,
wherein the flow of the coolant through the first fluid circuit and second fluid circuit is in parallel when coolant flows through the second fluid circuit.

14. The method of claim 13, further comprising controlling a flow rate of coolant in the second coolant circuit relative to a flow rate of coolant in the first coolant circuit.

15. The method of claim 14, wherein the controlling the flow rate of coolant in the second coolant circuit relative to a flow rate of coolant in the first coolant circuit includes:
providing a second coolant circuit valve disposed in the second coolant circuit; and
controlling a flow rate of coolant through the second coolant circuit using the second coolant circuit valve.

16. The method of claim 15, further including substantially shutting off the flow of coolant through the second coolant circuit when the fluid pump is thawed.

17. The method of claim 16, further including flowing coolant through the first coolant circuit when the fluid pump is thawed and the fluid tank is frozen.

18. The method of claim 14, wherein the controlling a flow rate of coolant in the second coolant circuit relative to a flow rate of coolant in the first coolant circuit includes controlling the flow rate of coolant through the second coolant circuit such that a fluid pump overheating time is greater than a fluid tank thawing time.

19. The method of claim 14, wherein the controlling the flow rate of coolant in the second coolant circuit relative to a flow rate of coolant in the first coolant circuit includes:
preselecting a relative size of a diameter of a conduit in the first coolant circuit and a diameter of a conduit in the second coolant circuit to provide a greater coolant flow rate in the first coolant circuit than at the second coolant circuit.

20. The method of claim 19 further including preselecting a maximum flow rate in the second coolant circuit based at least in part on a maximum coolant temperature such that a fluid pump overheating time as a function of the maximum flow rate and the maximum coolant temperature is greater than a fluid tank thawing time.
